(19) United States
(12) Patent Application Publication
(10) Pub. No.: US 2013/0210692 A1
(43) Pub. Date: Aug. 15, 2013

(54) CLEANING COMPOSITION AND METHOD OF FORMING THE SAME

(71) Applicant: BASF SE, (US)

(72) Inventors: Keith E. Gutowski, Royal Oak, MI (US); Patricia Harris, Woodhaven, MI (US)

(73) Assignee: BASF SE, Ludwigshafen (DE)

(21) Appl. No.: 13/765,786

(22) Filed: Feb. 13, 2013

Related U.S. Application Data
(60) Provisional application No. 61/598,052, filed on Feb. 13, 2012.

(51) Int. Cl. C11D 3/37; C11D 3/12; C11D 3/33; C11D 3/43

(52) U.S. Cl. CPC C11D 3/3749; C11D 3/43; C11D 3/1246; C11D 3/33
USPC 510/219; 510/218

(57) ABSTRACT

A cleaning composition comprises a chelating component. The chelating component is generally selected from the group of methylglycine-N—N-diacetic acid (MGDA), N,N-bis(carboxymethyl)-L-glutamate (GLDA), nitrilotriacetic acid (NTA), hydroxyethylethylenediaminetriacetic acid (HEDTA), ethylenediaminetetraacetic acid (EDTA), diethylenetriaminepentaacetic acid (DTPA), and mixtures thereof. The cleaning composition further comprises a builder component comprising a metal silicate and/or a metal carbonate. The cleaning composition further comprises a solvent component comprising an alkanolamine. The cleaning composition further comprises a polymer component comprising a polyacrylic acid (PAA) and/or an acrylic-maleic copolymer. Optionally, the cleaning composition can further comprise a surfactant component. The cleaning composition is useful for removing tough soil from a ware surface in a dishwasher, such as for removing proteinaceous, carbohydrate, and/or fatty materials from cookware, bakeware, tableware, dishware, flatware, and/or glassware in an automatic dishwasher. A method of forming the cleaning composition is also provided.

### CROSS REFERENCE TO RELATED APPLICATIONS

This application claims the benefit of U.S. Provisional Patent Application Ser. No. 61/598,052, filed on Feb. 13, 2012, which is incorporated herewith by reference in its entirety.

### FIELD OF THE INVENTION

The present invention generally relates to a cleaning composition, and more specifically to a cleaning composition for dishwashing with the cleaning composition comprising a chelating component, a builder component, a solvent component, and a polymer component and to a method of forming the cleaning composition.

### DESCRIPTION OF THE RELATED ART

Consumers often scrub tough soils from ware surfaces, e.g. bakeware, cookware, or dishware, prior to putting such surfaces into an automatic dishwasher. For example, consumers typically soak and scrub cookware and bakeware which has burnt or cooked on food, such as meat, eggs, etc. Such a process is messy, frustrating, and time consuming. In addition, aggressive soaking and/or scrubbing can irreparably damage certain ware surfaces, such as non-stick coatings or metals that are prone to corrosion. While conventional dishwasher compositions are often sufficient to clean easy to moderate soil from ware surfaces, they are not capable of cleaning tough soil from such surfaces. While consumers may attempt to utilize such compositions without first removing the tough soils themselves, they often discover that multiple wash cycles are necessary, or that hand washing is ultimately required to fully remove the tough soil. Even the slightest amount of leftover soil after cleaning the ware surface is undesirable and therefore, the consumer must often intervene at some point in time with supplemental cleaning or scrubbing.

In view of the foregoing, there remains an opportunity to provide improved cleaning compositions for removing tough soil from a ware surface in a dishwasher. There also remains an opportunity to provide methods of forming such cleaning compositions.

### SUMMARY OF THE INVENTION AND ADVANTAGES

The present invention provides a cleaning composition. The cleaning composition is useful for removing tough soils from ware surfaces. The cleaning composition comprises A) a chelating component. The chelating component is generally selected from the group of a1) methylglycine-N—N-diacetic acid (MGDA), a2) N,N-bis(carboxymethyl)-L-glutamate (GLDA), a3) nitrilotriacetic acid (NTA), a4) hydroxyethylethylenediaminetriacetic acid (HEDTA), a5) ethylenediaminetetraacetic acid (EDTA), a6) diethylenetriaminepentaacetic acid (DTPA), and a7) mixtures thereof. The cleaning composition further comprises B) a builder component. The builder component generally comprises b1) a metal silicate and/or b2) a metal carbonate. The cleaning composition further comprises C) a solvent component. The solvent component generally comprises an alkanolamine. The cleaning composition further comprises D) a polymer component. The polymer component generally comprises d1) a polyacrylic acid (PAA) and/or d2) an acrylic-maleic copolymer.

The present invention also provides a method of forming the cleaning composition. The method comprises the steps of providing the chelating component, providing the builder component, providing the solvent component, and providing the polymer component. The method further comprises the step of combining the chelating component and the polymer component to form a first mixture. The method further comprises the steps of heating the first mixture from a first temperature to a second temperature, and combining the builder component and the first mixture to form a second mixture. The method yet further comprises the steps of cooling the second mixture from about the second temperature down to a third temperature, and combining the solvent component and the second mixture to form the cleaning composition.

The cleaning composition provides excellent cleaning of tough soil from a ware surface, e.g. bakeware, cookware, and dishware. The cleaning composition may be used for automatic dishwasher applications. In general, auxiliary compositions are not necessary in addition to the cleaning composition.

### DETAILED DESCRIPTION OF THE INVENTION

The present invention provides a cleaning composition. While the cleaning composition can be used for various applications, the cleaning composition is especially useful for removing tough soils from ware surfaces. The cleaning composition can be used on a variety of different soils and ware surfaces. Examples of such ware surfaces include those found with cookware, bakeware, tableware, dishware, flatware, and glassware. Specific examples of ware surfaces include stainless steel and glass, e.g. Pyrex®. The cleaning composition can also be useful for removing and/or preventing spotting and filming on ware surfaces. Examples of tough soils include those that comprise a proteinaceous material, such as baked, burnt, or cooked on egg, meat, etc. Other tough soils include baked, burnt, or cooked on carbohydrates (e.g. oatmeal), fats, etc. The cleaning composition has been found to be especially useful for removing burnt or cooked on food from pots and pans. The invention cleaning composition is not limited to any particular soil or ware surface.

The cleaning composition can be in various forms, such as a liquid, powder, granular, paste, gel, etc. In certain embodiments, the cleaning composition is in the form of a paste. Water or another conventional solvent, diluent, or carrier, can be added or removed to change the form of the cleaning composition. The cleaning composition can be in various forms and provided in various fashions, such as by pouch, sachet, capsule, pod, free form, etc.

The cleaning composition has been found to be useful in dishwashing applications, especially in automatic dishwasher (ADW) applications. The cleaning composition may also be useful for industrial and institutional (I&I) cleaning applications. The invention cleaning composition can be used alone, or in combination with one or more additional compositions, such as a conventional detergent composition, rinse aid, etc. The cleaning composition is not limited to any particular use.

In various embodiments, the cleaning composition comprises a chelating component, a builder component, a solvent component, and a polymer component. In further embodiments, the cleaning composition consists essentially of the chelating, builder, solvent, and polymer, components. In further embodiments still, the cleaning composition consists of the chelating, builder, solvent, and polymer, components. In certain embodiments, the cleaning composition includes one or more additional components, such as an additive, a surfactant, etc. The various components of the cleaning composition are described below.

The chelating component may comprise one or more chelating agents, such as an aminocarboxylate. The chelating agent may also be referred to in the art as a complexing agent. The chelating component is useful for inactivating hardness minerals and/or metallic ions, e.g. Ca²⁺ and Mg²⁺. Typically, the chelating agent will combine with hardness minerals and hold them in solution such that the hardness minerals cannot redeposit. The chelating component also provides some detergency boosting.

In certain embodiments, the chelating component comprises methylglycine-N—N-diacetic acid (MGDA). MGDA may also be referred to in the art as methylglycin diacetic acid. As used herein, the chelating component may be in an acidic, partially acidic, or salt form. For example, in certain embodiments the MGDA can be in the form of a salt, more typically in the form of an alkali salt, e.g. methylglycine diacetate, trisodium salt (Na₃.MGDA). MGDA is also commonly referred to in the art as methylglycine diacetate. As used herein, the alkali salt may include any alkali or alkaline earth metal and is not particularly limited. In other embodiments, the chelating component comprises at least one of nitrilotriacetic acid (NTA), hydroxyethylethylenediaminetriacetic acid (HEDTA), N,N-bis(carboxymethyl)-L-glutamate (GLDA), ethylenediaminetetraacetic acid (EDTA), diethylenetriaminepentaacetic acid (DTPA), and/or a salt thereof, more typically the alkali salt thereof, of any of the proceeding chelating agents.

In certain embodiments, the chelating component comprises GLDA. GLDA may also be referred to in the art as glutamic acid diacetic acid. The chelating component can comprise a combination or mixture of two or more of the chelating agents, e.g. MGDA and GLDA. As alluded to above, the acronyms used herein, e.g. MGDA, can refer to the acid/acidic, partially acidic, or salt form of the respective chelating agent. The chelating component is generally in the form of a salt, e.g. Na₃.MGDA.

In certain embodiments, the chelating component is aqueous, such that the chelating component also includes water in addition to the chelating agent. In various embodiments, the chelating component is aqueous, such that the chelating agent, e.g. MGDA, is present in the chelating component in amounts of from about 35 to about 95, from about 35 to about 85, or from about 35 to about 45, or about 40, parts by weight, each based on 100 parts by weight of the chelating component, or any range between the lowest and highest of these values. The chelating component may also be in the form of a powder, granular, or a gel, such that the chelating agent is the chelating component. In other words, the chelating component can consist essentially of, or consist of, the chelating agent.

Non-limiting examples of suitable chelating components are commercially available from ® ® BASF Corporation of Florham Park, N.J., under the trade name TRILON®, such as TRILON® M, TRILON® A, TRILON® B, TRILON® C, and TRILON® D. Further non-limiting examples of suitable chelating components are commercially available from AkzoNobel of Chicago, Ill., under the trade name DISSOLVINE® GL, such as DISSOLVINE® GL 47S.

The chelating component can be used in various amounts. Typically, the chelating component is present in the cleaning composition in an amount of from about 10 to about 55, about 15 to about 50, about 15 to about 45, about 17.5 to about 42.5, about 19 to about 40, or about 38.5, weight % (wt %), each based on 100 parts by weight of the cleaning composition, or any range between the lowest and highest of these values. Typically, the amounts described herein are based on the assumption that the component includes 100% actives, e.g. 100% chelating agent. As such, if the component is aqueous, the amounts thereof can be adjusted accordingly to compensate for % actives dilution. The same methodology also applies to the other components of the cleaning composition, if applicable.

The builder component is useful for providing alkalinity for the clean composition. The builder component can also provide softening. Typically, the builder component comprises a metal silicate and/or a metal carbonate. The metal may be any alkali metal or alkaline earth metal. Typically, the metal is sodium (Na) or potassium (K). However, the metal is not limited and may alternatively include a transition metal. In certain embodiments, the builder component comprises a sodium silicate (also known as sodium metasilicate) and/or sodium carbonate. Examples of additional non-limiting compounds that can be utilized include sodium bicarbonate, sodium aluminosilicate, and combinations thereof.

In various embodiments, the builder component comprises sodium metasilicate (pentahydrate). In further embodiments, the sodium metasilicate has a SiO₂:Na₂O ratio of from about 1:1 to about 3:1, about 1:1 to about 2.5:1, about 1:1 to about 2:1, about 1:1 to about 1.5:1, or about 1:1, or any range between the lowest and highest of these values. Specific examples of suitable sodium metasilicates are commercially available from PQ Corporation of Malvern, Pa., under the name of METSO®, such as METSO® Pentabead 20 and METSO® Beads 2048.

In other embodiments, the builder component comprises sodium carbonate, which is also commonly referred to in the art as “soda ash,” especially when in an anhydrous form, or as “washing soda” when in a hydrated/crystalline form. Suitable grades of metal carbonates are commercially available from a variety of suppliers.

The builder component can be used in various amounts. Typically, the builder component is present in the cleaning composition in an amount of from about 20 to about 60, about 25 to about 55, about 25 to about 50, about 28 to about 48, or about 33.8, wt %, each based on 100 parts by weight of the cleaning composition, or any range between the lowest and highest of these values. As described above, these amounts are based on the assumption of 100% actives, and can be adjusted to account for the presence of diluent(s), if present in the builder component.

The solvent component is useful for soil swelling. Typically, the solvent component comprises an alkanolamine. Various types of alkanolamines can be utilized, such as triisopropanolamine, N-methyldiethanolamine, and N-ethyldiethanolamine. In certain embodiments, the alkanolamine is an ethanolamine. Further examples of suitable ethanolamines include monoethanolamine (MEA), diethanolamine, triethanolamine, diethylethanolamine, triisopropanolamine, and dimethylethanolamine. In one embodiment, the cleaning composition comprises MEA. Suitable grades of alkanolamines are commercially available from a variety of suppliers, such as from BASF Corporation.

The solvent component can be used in various amounts. Typically, the solvent component is present in the cleaning composition in an amount of from about 0.5 to about 30, about 1 to about 25, about 2.5 to about 22.5, about 3 to about 20, about 4 to about 19, or about 13.2, wt %, each based on 100 parts by weight of the cleaning composition, or any range between the lowest and highest of these values. As described above, these amounts are based on the assumption of 100% actives, and can be adjusted to account for the presence of other types of diluent(s), if present in the solvent component.

The polymer component is useful for keeping particles of soil that have been removed from wares in a dispersed or suspended state such that the particles are more readily removed from the dishwasher when the wash water is pumped out. The polymer component can also boost cleaning. Typically, the polymer component comprises carboxylate functional polymer or a modified carboxylate functional polymer. In certain embodiments, the polymer component comprises a polyacrylic acid (PAA) and/or an acrylic/maleic copolymer. In one embodiment, the polymer component comprises PAA. Examples of suitable polymeric components are commercially available from BASF Corporation under the trade name SOKALAN®, such as SOKALAN® PA 30 CL.

In some embodiments, the polymer component comprises a modified carboxylate functional polymer. Various type of modification can be used. For example, the polymer may have one or more additional functional groups, which may be the same or different from each other. Examples of such groups include polyether groups, sulfonate groups, hydrophobe groups, alkyl chains, phosphate groups, amide groups, olefin groups, PEG groups, etc. Such groups may be part of or grafted onto a polymeric backbone of the polymer. Other types of polymers may also be used.

The polymer component can be used in various amounts. Typically, the polymer component is present in the cleaning composition in an amount of from about 5 to about 40, about 10 to about 37.5, about 12.5 to about 35, about 13 to about 32.5, about 14 to about 30, or about 14.5, wt %, each based on 100 parts by weight of the cleaning composition, or any range between the lowest and highest of these values. As described above, these amounts are based on the assumption of 100% actives, and can be adjusted to account for the presence of diluent(s), if present in the polymer component.

Without intending to be bound or limited by any particular theory, it is believed that a synergy exists between the total amounts of the chelating, builder, polymer, and solvent, components. In other words, various amounts of the different components can be customized to maximize cleaning efficiency and performance depending on what type of soil is to be removed. The synergy and the customization of various embodiments of this invention are represented below in a series of non-limiting equations. Specifically, in various embodiments, the invention cleaning composition is represented by at least one of the following non-limiting equations X and/or Y immediately below:

X=(2.0*A)+(2.5*B)+(5.0*C)+(5.0*D)+(−5.9*A*B)+(−7.9*A*C)+(−5.9*A*D)+(−12.9*B*C)+(5.1*B*D)+(−3.9*C*D)+(−0.07*A*B*C)+(−39.8*A*B*D)+(17.9*A*C*D)+(−58.6*B*C*D); and

Y=(1.75*A)+(0.75*B)+(5.0*C)+(5.0*D)+(−0.95*A*B)+(−8.45*A*C)+(−3.45*A*D)+(−5.95*B*C)+(6.55*B*D)+(−13.95*C*D)+(18.0*A*B*C)+(−34.5*A*B*D)+(4.5*A*C*D)+(3.0*B*C*D).

In the non-limiting equations above, “X” is generally the “meat cleaning performance” of the cleaning composition and “Y” is generally the “egg cleaning performance” of the cleaning composition. Said another way, the embodiments of the cleaning composition established by equation X are especially useful for applications where removing meat-based soils is desirable (e.g. soils based on bacon, sausage, ham, etc.), whereas the embodiments of the cleaning composition established by equation Y are especially useful for applications where removing egg-based soils is desirable (e.g. soils based on chicken eggs). “A” is the weight fraction of the chelating component (e.g. MGDA), “B” is the weight fraction of the builder component (e.g. sodium metasilicate), “C” is the weight fraction of the polymer component (e.g. PAA), “D” is the weight fraction of the solvent component (e.g. MEA), and A+B+C+D=1. Typically, 0≦A≦1, or 0<A<1. Typically, 0≦B≦1, or 0<B<1. Typically, 0≦C≦1, or 0<C<1. Typically, 0≦D≦1, or 0<D<1. Each of these ranges can individually be further narrowed to any number of smaller sub-ranges between 0 and 1.

The weight fractions above are based on the total amount of the chelating component, builder component, polymer component, and solvent component present in the cleaning composition. These amounts are based on the assumption that each of the components is 100% active, as described above. Both X and Y can vary from 0 to 5, with 0 generally representing 100% cleaning performance and 5 generally indicating 0% cleaning performance. As such, lower X and Y values are considered “more clean” relative to higher X and Y values, which are considered “less clean”. As such, X is typically less than 5, less than 4, less than 3, less than 2, or less than 1, or any value between 0 and 5. Further, Y is typically less than 5, less than 4, less than 3, less than 2, or less than 1, or any value between 0 and 5.

By setting X and/or Y at a desired cleaning performance value (e.g. 3.5, 3, or 2.5), one can determine/calculate the various possible ranges for each of the respective components of the cleaning composition. Further, with reference to the equations themselves, and more specifically, each of the coefficients above, one can appreciate how each of the components impact the cleaning performance of the cleaning composition, both individually, and in combination with one another. For example, referring to the X equation, it is shown that each of components A through D have an additive effect to the value of X (i.e., their presence increases X, which is generally undesirable). However, the combination of A, B, and D (having a coefficient of −39.8), as well as the combination of B, C, and D (having a coefficient of −58.6), decrease the value X, greater than the sum that each of the individual components add to X. This same type of interpretation can be appreciated with reference to the Y equation.

In situations where it is more desirable to have excellent meat cleaning performance for the cleaning composition, the X equation can be prioritized, more heavily weighted, or deemed more important, relative to the Y equation, such that one can determine the appropriate amounts of each of the components in a way which leans more favorably toward meat cleaning performance. Conversely, in situations where it is more desirable to have excellent egg cleaning performance for the cleaning composition, the Y equation can be prioritized, more heavily weighted, or deemed more important, relative to the X equation, such that one can determine the appropriate amounts of each of the components in a way which leans more favorably toward egg cleaning performance. Alternatively, where it is desirable to have meat and egg cleaning performance for the cleaning composition, both the X and Y equations can be weighted equally (or there about). Utilizing “goal seek” methodology is one way to determine the respective A, B, C, and D values for the equations once the desired X and/or Y values are set. Other suitable methodologies for application of these equations are understood by those skilled in the art. An example of a software program which can be utilized along with the equations is JMP®, which is commercially available from SAS Institute Inc. of Cary, N.C.

In certain embodiments, the cleaning composition further comprises a surfactant component. It is believed that in these embodiments, including the surfactant component assists in dissolving and/or emulsifying certain types of tough soils. The surfactant component is also useful for surface wetting which helps deliver the cleaning composition to the ware surface. If utilized, the surfactant component is typically selected from the group of nonionic surfactants, anionic surfactants, amphoteric surfactants, cationic surfactants, and ionic surfactants. It is to be appreciated that other types of surfactants can also be used.

Nonionic surfactants, suitable for purposes of the present invention, include polyalkylene oxide surfactants (also known as polyoxyalkylene surfactants or polyalkylene glycol surfactants). Suitable polyalkylene oxide surfactants include polyoxypropylene surfactants and polyoxyethylene glycol surfactants. Suitable surfactants of this type are synthetic organic polyoxypropylene (PO)-polyoxyethylene (EO) block copolymers. These surfactants generally comprise a di-block polymer comprising an EO block and a PO block, a center block of polyoxypropylene units (PO), and having blocks of polyoxyethylene grafted onto the polyoxypropylene unit or a center block of EO with attached PO blocks. Further, this surfactant can have further blocks of either polyoxyethylene or polyoxypropylene in the molecules. The surfactant may also include butylene oxide (BO) blocks, and can include random incorporations of two or three alkylene oxides, e.g. EO/PO/BO, EO/PO/PO, EO/EO/PO, etc. Such surfactants may be referred to in the art as “heteric” block surfactants.

Additional nonionic surfactants, suitable for purposes of the present invention, include alcohol alkoxylates. Suitable alcohol alkoxylates include linear alcohol ethoxylates. Additional alcohol alkoxylates include alkylphenol ethoxylates, branched alcohol ethoxylates, secondary alcohol ethoxylates, castor oil ethoxylates, alkylamine ethoxylates (also known as alkoxylated alkyl amines), tallow amine ethoxylates, fatty acid ethoxylates, sorbital oleate ethoxylates, end-capped ethoxylates, or combinations thereof. Further nonionic surfactants include amides such as fatty alkanolamides, alkyldiethanolamides, coconut diethanolamide, lauramide diethanolamide, cocoamide diethanolamide, polyethylene glycol cocoamide, oleic diethanolamide, or combinations thereof. Yet further nonionic surfactants include polyalkoxylated aliphatic base, polyalkoxylated amide, glycol esters, glycerol esters, amine oxides, phosphate esters, alcohol phosphate, fatty triglycerides, fatty triglyceride esters, alkyl ether phosphate, alkyl esters, alkyl phenol ethoxylate phosphate esters, alkyl polysaccharides, block copolymers, alkyl polyglucocides, or combinations thereof.

Non-limiting examples of suitable surfactant components are commercially available from BASF Corporation, under the trade name LUTENSOL®, such as LUTENSOL® XP 80, LUTENSOL® TO 8, LUTENSOL® GD 70; under the trade name TETRONIC®, such as TETRONIC® 304; under the trade name PLURAFAC®, such as PLURAFAC® SLF 180 and PLURAFAC® LF 711; as well as under the trade name LUTENSIT®, such as LUTENSIT® AS 2230. Further non-limiting examples are commercially available from Huntsman, under the trade names of EMPILAN®, such EMPILAN® KB and EMPILAN® KC; SURFONIC® L12; TERIC® 12A; and ECOTERIC®, such as ECOTERIC® B30 and ECOTERIC® B35. Further non-limiting examples are commercially available from Croda, under the trade name of NatSurf™, such as NatSurf™ 265. Further non-limiting examples are commercially available from Stepan, under the trade name of BIO-SOFT®, including the BIO-SOFT® N1, N23, and N91 series. Yet further non-limiting examples are commercially available from Air Products, under the trade names of NONIDET® and TOMADOL®.

If utilized, the surfactant component can be used in various amounts. In certain embodiments, the surfactant component is present in the cleaning composition in an amount of from about 0.5 to about 10, about 0.5 to about 7.5, about 1 to about 7, about 2 to about 5, or about 2, wt %, each based on 100 parts by weight of the cleaning composition, or any range between the lowest and highest of these values. As described above, these amounts are based on the assumption of 100% actives, and can be adjusted to account for the presence of diluent(s), if present in the surfactant component.

In certain embodiments, at least one of the chelating component and the solvent component is a complex comprising the reaction product of an alkanesulfonic acid. The complexes may also be referred to in the art as reaction products or salts. Such salts can be formed beforehand or in situ, typically beforehand.

The alkanesulfonic acid can be a short chain alkanesulfonic acid, such as one containing from 1 to 4 carbon atoms (e.g. one having propyl, ethyl, or methyl moieties). Typically, the alkanesulfonic acid is methanesulfonic acid (MSA). Suitable grades of MSA are commercially available from BASF Corporation under the trade name LUTROPUR®, such as LUTROPUR® MSA. The alkanesulfonic acid can be used in various amounts.

As introduced above, the alkanesulfonic acid can be used in a complex, i.e., a salt. In certain embodiments, the acid, e.g. MSA, is complexed with the chelating component, e.g. MGDA. In other embodiments, the acid, e.g. MSA, is complexed with the solvent component, e.g. MEA. Such embodiments can be used for various purposes. For example, the complex(es) can be used to change form of the cleaning composition from liquid to solid. In addition, the complex(es) can be used to control pH of the cleaning composition.

Optionally, the cleaning composition may include one or more additives. Any type of additive can be utilized, especially additives which are conventionally used in ADW applications. Examples of suitable additives include water, supplemental builder components such as metal citrates, bleaches, enzymes, solvents, salts, soil release polymers, foam inhibitors, complexing agents, fragrances, fillers, inorganic extenders, formulation auxiliaries, solubility improvers, dyes, corrosion inhibitors, peroxide stabilizers, electrolytes, soaps, detergents, acids such as MSA, amidosulfonic acid, citric acid, lactic acid, acetic acid, peracids, and trichloroisocyanuric acid, solvents such as ethylene glycol, 2-butoxyethanol, butyldiglycol, alkyl glycol ethers, and isopropanol, perfumes, oils, oxidizing agents such as perborates, dichloroisocyanurates, interface-active ethyleneoxy adducts, surfactants, and combinations thereof.

The cleaning composition typically has a pH of from about 7 to about 13, about 8 to about 13, or about 9 to about 12, or any range between the lowest and highest of these values. The pH of the cleaning composition is generally imparted by the type and amount of components utilized to form the cleaning composition. pH buffer systems, e.g. a phosphate buffer or a citrate buffer, may be used for stabilizing the pH; however, they are not required.

In certain embodiments, the cleaning composition is substantially free of phosphorus-containing compounds, making the cleaning composition more environmentally acceptable. Phosphorus-free refers to a composition, mixture, or ingredients to which phosphorus-containing compounds are not added. Should phosphorus-containing compounds be present through contamination of a phosphorus-free composition, mixture, or ingredient, the level of phosphorus-containing compounds in the resulting cleaning composition is typically less than about 0.5, less than about 0.1, or less than about 0.01, wt %, each based on 100 parts by weight of the cleaning composition. In various embodiments, the cleaning composition completely excludes phosphorus-containing compounds.

In various embodiments, the cleaning composition is free of a chlorine-containing component. Examples of components containing chlorine include chlorine bleaches, which generally belong to a group of strong oxidizing agents, all of which have one or more chlorine atoms in their molecule. Specific examples of chlorine bleaches used in the art include chlorinated isocyanurates, chlorinated trisodium phosphate, hypochlorite, and sodium hypochlorite. By free of a chlorine-containing component, it is generally meant that the cleaning composition is free of a purposefully added component including chlorine, such as the addition of chlorine bleach, e.g. sodium hypochlorite. In some embodiments, the cleaning composition includes some trace amount of chlorine, such as a trace amount of chlorine present in one or more of the components.

In various embodiments, the cleaning composition includes chlorine in an amount of from about 0.50 to approaching zero (0), about 0.25 to approaching 0, or about 0.10 to approaching 0, wt %, each based on 100 parts by weight of the cleaning composition. In certain embodiments, the cleaning composition completely excludes chlorine.

In some embodiments, the cleaning composition is free of a bleach component. While chlorine bleaches tend to be commonly used bleach components, other bleaches include non-chlorine bleaches, such as peroxygen compounds, which release active oxygen in wash water. Further examples of non-chlorine bleaches include perborates/sodium perborates, potassium monopersulfates, sodium percarbonates, hydrogen peroxides, and organic peracids. In various embodiments, the cleaning composition includes the bleach component in an amount of from about 15 to approaching zero (0), about 10 to approaching 0, about 5.0 to approaching 0, or about 1.0 to approaching 0, wt %, each based on 100 parts by weight of the cleaning composition. In certain embodiments, the cleaning composition completely excludes the bleach component.

The present invention also provides a method of forming the cleaning composition. The method comprises the steps of providing the chelating component, providing the builder component, providing the solvent component, and providing the polymer component. The method further comprises the step of combining the chelating component and the polymer component to form a first mixture. The first mixture is typically mixed for a period of time. The amount of time can vary based, for example, on the volume of the first mixture, form of the components, etc. Typically, at least one of or both of the chelating component and polymer component are liquids. In the alternative, water may be separately added for forming the first mixture.

The method further comprises the step of heating the first mixture from a first temperature to a second temperature. The first temperature can be ambient, e.g. about room temperature, or hotter or cooler than room temperature. The second temperature is typically from about 45 to about 65° C., but can also be hotter or cooler. The second temperature is generally high enough to ensure dissolution of the builder component as described below.

The method further comprises the step of combining the builder component and the first mixture to form a second mixture. Typically, the builder component is a solid, e.g. a powder. The second mixture is typically mixed for a period of time to ensure dissolution of the builder component into the second mixture. The amount of time can vary based, for example, on the volume of the second mixture.

The method further comprises the step of cooling the second mixture from about the second temperature down to a third temperature. Active or passive cooling can be utilized. Typically, the third temperature is higher than a solidification temperature of the second mixture such that the solvent component can be incorporated as described below.

The method further comprises the step of combining the solvent component and the second mixture to form the cleaning composition. Typically, the solvent component is a liquid. Adding the solvent component after cooling of the second mixture is useful to prevent evaporation of the solvent component. However, the solvent component should be added prior to solidification of the second mixture. Typically, the cleaning composition is in the form of a paste. The paste can be used as is, may be let down with a solvent/diluent to form a liquid, or further dried and milled to obtain a powder. If utilized, other components, such as the surfactant component, can be added at various points in time. Typically, heating and cooling is taken into account prior to adding such components. For example, if the surfactant component is volatile, it will generally be added during or after cooling of the second mixture to prevent premature volatilization.

The following examples, illustrating the cleaning compositions of the present invention, are intended to illustrate and not to limit the invention.

### EXAMPLES

Various formulations of the cleaning composition are prepared using the method as described above. The cleaning compositions are used to clean stainless steel and glass (Pyrex®) panels utilizing simulated test methods and/or automatic dishwashing machines. Conventional dishwasher times, temperatures, and amounts of water are utilized. For example, conventional dishwashers generally have wash cycles that last from about 30 to about 120 minutes, have washing temperatures of from about 100 to about 130° F., and use about 1 to about 3 liters of water.

Meat and egg is baked and/or cooked onto the panels to simulate tough soils on the ware surfaces. After a wash cycle, the panels are visually inspected to determine percentage removal of the tough soils from the ware surfaces. All values in Table I below are in wt % based on 100 parts by weight of the respective cleaning composition.

TABLE I

| Component | Example 1 | Example 2 | Example 3 | Further Examples |
|---|---|---|---|---|
| Chelating | 38.5 | 37.7 | 22.3 | 19-40 |
| Polymer | 14.5 | 14.2 | 26.8 | 14-30 |
| Builder | 33.8 | 33.1 | 38.9 | 28-48 |
| Solvent | 13.2 | 12.9 | 12.1 | 4-19 |
| Surfactant | 0 | 2.0 | 0 | 0-10 |

All amounts in Table I above are based on the assumption that each of the components includes 100% actives. As such, should one or more of the components include a diluent, e.g. water, the amount of the component should be increased to account for such dilution. For example, if the Chelating Component is aqueous and includes 40% actives, and 38.5 parts chelating agent is required (e.g. in Example 1 above), than the amount of Chelating Component required is 38.5/40*100 or ˜96.25 parts by weight aqueous Chelating Component. Such calculations can be used to account for various types and/or concentrations of components.

Chelating Component is MGDA commercially available from BASF Corporation.

Polymer Component is PAA commercially available from BASF Corporation.

Builder Component is sodium metasilicate with a SiO2:Na2O ratio of 1:1, commercially available from PQ Corporation.

Solvent component is MEA commercially available from BASF Corporation.

Surfactant Component is a low foaming, alcohol alkoxylate, nonionic surfactant, commercially available from BASF Corporation.

The cleaning compositions provide excellent cleaning results. All of the Examples remove 95% or more of the tough soils from the panels. Examples 1 and 2 are especially good at removing the tough soil from stainless steel and glass. Further, Examples 1 and 2 are especially useful for removing both egg and meat from the surfaces, whereas Example 3 is especially useful for removing meat from surfaces, more so than Examples 1 and 2. However, Example 3 is not as useful for removing egg relative to Examples 1 and 2. As such, the Further Examples are tailored toward particular cleaning needs, such as the need for removing egg and/or meat.

As described above with respect to the X and Y equations, various calculations can be utilized to obtain desired cleaning performance characteristics of the invention cleaning composition. In Examples 1 and 2 above, both the X and Y equations are each weighted equally important, e.g. 0.5 each for an importance factor, whereas in Example 3, the X equation is given an importance factor of 1 and the Y equation is given an importance factor of 0. By setting desired values and importance factors for each of the X and Y equations, the amounts of each of the components can be determined/back-calculated, e.g. by utilizing JMP software, Goal Seek in Excel, etc.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A cleaning composition for removing tough soil from a ware surface, said cleaning composition comprising:
A) a chelating component selected from the group of;
a1) methylglycine-N—N-diacetic acid (MGDA),
a2) N,N-bis(carboxymethyl)-L-glutamate (GLDA),
a3) nitrilotriacetic acid (NTA),
a4) hydroxyethylethylenediaminetriacetic acid (HEDTA),
a5) ethylenediaminetetraacetic acid (EDTA),
a6) diethylenetriaminepentaacetic acid (DTPA), and
a7) mixtures thereof;
B) a builder component comprising;
b1) a metal silicate, and/or
b2) a metal carbonate;
C) a solvent component comprising an alkanolamine; and
D) a polymer component comprising;
d1) a polyacrylic acid (PAA), and/or
d2) an acrylic-maleic copolymer.

2. The cleaning composition as set forth in claim 1 wherein said chelating component is present in an amount of from about 10 to about 55 weight percent (wt %) based on 100 parts by weight of said cleaning composition.

3. The cleaning composition as set forth in claim 2 wherein said chelating component comprises MGDA.

4. The cleaning composition as set forth in claim 1 wherein said builder component is present in an amount of from about 20 to 60 weight percent (wt %) based on 100 parts by weight of said cleaning composition.

5. The cleaning composition as set forth in claim 4 wherein said builder component comprises a sodium metasilicate.

6. The cleaning composition as set forth in claim 5 wherein said sodium metasilicate has a SiO₂:Na₂O ratio of from about 1:1 to about 3:1.

7. The cleaning composition as set forth in claim 1 wherein said solvent is present in an amount of from about 0.5 to about 30 weight percent (wt %) based on 100 parts by weight of said cleaning composition.

8. The cleaning composition as set forth in claim 7 wherein said alkanolamine comprises an ethanolamine.

9. The cleaning composition as set forth in claim 8 wherein said ethanolamine is monoethanolamine (MEA).

10. The cleaning composition as set forth in claim 1 wherein said polymer component is present in an amount of from about 5 to about 40 weight percent (wt %) based on 100 parts by weight of said cleaning composition.

11. The cleaning composition as set forth in claim 10 wherein said polymer component comprises PAA.

12. The cleaning composition as set forth in claim 1 wherein said chelating component is present in an amount of from about 15 to about 50 weight percent (wt %), said builder component is present in an amount of from about 25 to 55 wt %, said solvent is present in an amount of from about 1 to about 25 wt %, and said polymer component is present in an amount of from about 10 to about 35 wt %, each based on 100 parts by weight of said cleaning composition.

13. The cleaning composition as set forth in claim 1 further comprising a surfactant component.

14. The cleaning composition as set forth in claim 1 wherein at least one of said chelating component and said solvent component is further defined as a complex comprising the reaction product of an alkanesulfonic acid.

15. The cleaning composition as set forth in claim 14 wherein:
i) said alkanesulfonic acid is methanesulfonic acid (MSA); and
ii) said complex comprises the reaction product of said MSA and said MGDA or the reaction product of said MSA and said alkanolamine.

16. The cleaning composition as set forth in claim 1 free of a bleach compound and/or free of a phosphorus-containing compound.

17. The cleaning composition as set forth in claim 1 wherein:
i) the ware surface is further defined as cookware, bakeware, tableware, dishware, flatware, or glassware; and/or
ii) the tough soil comprises a proteinaceous, carbohydrate, and/or fatty material.

18. A cleaning composition for removing tough soil from a ware surface, said cleaning composition comprising:
A) from about 10 to about 55 weight percent (wt %) of a chelating component comprising methylglycine-N—N-diacetic acid (MGDA);
B) from about 20 to about 60 wt % of a builder component comprising a metal silicate;
C) from about 0.5 to about 30 wt % of a solvent component comprising an alkanolamine; and
D) from about 5 to about 40 wt % of a polymer component comprising a polyacrylic acid (PAA);
wherein each wt % is based on 100 parts by weight of said cleaning composition.

19. A method of forming a cleaning composition for removing tough soil from a ware surface, said method comprising the steps of:
providing A) a chelating component selected from the group of;
a1) methylglycine-N—N-diacetic acid (MGDA),
a2) N,N-bis(carboxymethyl)-L-glutamate (GLDA),
a3) nitrilotriacetic acid (NTA),
a4) hydroxyethylethylenediaminetriacetic acid (HEDTA),
a5) ethylenediaminetetraacetic acid (EDTA),
a6) diethylenetriaminepentaacetic acid (DTPA), and
a7) mixtures thereof;
providing B) a builder component comprising;
b1) a metal silicate, and/or
b2) a metal carbonate;
providing C) a solvent component comprising an alkanolamine;
providing D) a polymer component comprising;
d1) a polyacrylic acid (PAA), and/or
d2) an acrylic-maleic copolymer;
combining the chelating component and the polymer component to form a first mixture;
heating the first mixture from a first temperature to a second temperature;
combining the builder component and the first mixture to form a second mixture;
cooling the second mixture from about the second temperature down to a third temperature; and
combining the solvent component and the second mixture to form the cleaning composition.

20. The method as set forth in claim 19 wherein:
i) the chelating component and the polymer component are each a liquid, the builder component is a solid, the solvent component is a liquid, and the cleaning composition is a paste; and/or
ii) the second temperature is from about 45 to about 65° C.
